(19) United States
(12) Patent Application Publication
(10) Pub. No.: US 2008/0084392 A1
(43) Pub. Date: Apr. 10, 2008

(54) Optical Mouse and Method of Use

(75) Inventor: Vincent Potenzone, Barrington, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/623,338

(22) Filed: Jan. 16, 2007

Related U.S. Application Data
(60) Provisional application No. 60/849,282, filed on Oct. 4, 2006.

(51) Int. Cl. G09G 5/08

(52) U.S. Cl. 345/166

(57) ABSTRACT

An optical mouse device that includes a light source and an object, such as an operator's hand or other instrument that is disposed in the path of the light energy to reflect the light energy emitted from the light source. At least one sensor unit receives the reflected light energy and generates electrical signals based on the received reflected light energy. The electrical signals may be used to control an apparatus, such as a cursor on a computer screen, operating table, or industrial machinery.

### CROSS-REFERENCE TO RELATED APPLICATIONS

This application claims a priority benefit to provisional application Ser. No. 60/849,282, filed on Oct. 4, 2006 and entitled “HIGH RELIEF OPTICAL MOUSE”, which is hereby incorporated by reference in its entirety herein.

### BACKGROUND

1. Field of the Invention

This invention relates generally to a mouse apparatus for use with a computer. More particularly, the present invention is directed to utilizing a mouse to identify a position of a user's hand and thereby control a processor or other device without requiring the user's hand to physically contact the mouse.

2. Background Discussion

Typically, when a conventional optical mouse is moved over an image detection surface, the optical mouse detects the image located on the concave region and the convex region of the image detection surface through an image detection unit. Next, the optical mouse executes an optical energy level transformation via a circuit unit to calculate the displacement and the direction of displacement. Subsequently, any movements a user performs on the optical mouse are mirrored by the cursor on a display unit.

A typical optical mouse requires a user to touch the mouse chassis in order to provide input to a piece of hardware. However, there are situations, such as medical procedures and hazardous industrial applications, when it may be undesirable for the operator to touch the mouse chassis. During a surgical procedure, for example, a doctor may need to keep his or her hands sterile. Controlling a computer or other device by touching a conventional optical mouse could contaminate the doctor's hand.

One example of a conventional optical mouse is described in U.S. Pat. No. 7,081,612, issued on Jul. 25, 2006 to Lu. The optical mouse includes a light projection apparatus, a light source, an image-forming lens and an image detection unit. The light projection apparatus has a light-guiding body with a convex lens surface, a first incline surface, a second incline surface and a light-emitting surface. A transparent medium, such as a glass, is disposed on the image detection surface. Light emitting from the light source enters the light-guiding body through the convex lens surface and is reflected from the first incline surface to the second incline surface. Next, the light is reflected by the second incline surface to form a light beam and is transmitted to a transparent medium. The light beam passes through the transparent medium and is projected to the image detection surface. U.S. Pat. No. 7,081,612, issued on Jul. 25, 2006 to Lu is hereby incorporated by reference in its entirety herein.

Another example of a conventional optical mouse is described in U.S. Pat. No. 7,088,338 issued on Aug. 8, 2006 to Ahn. This optical mouse includes an image sensor, which includes a plurality of pixels, for outputting signals accumulated in a given time as a pixel unit. The optical mouse also utilizes an A/D (analog-to-digital) converter and calculates a moving value of the position of the optical mouse. A system controller controls a data flow between an external system, an average value calculator calculating an average value, and a pick-up state discriminator generates a pick-up state signal. The optical mouse also includes a fluorescent lamp state discriminator for discriminating whether the optical mouse is in a fluorescent lamp state and for generating a fluorescent lamp state signal. U.S. Pat. No. 7,088,338 issued on Aug. 8, 2006 to Ahn is hereby incorporated by reference in its entirety herein.

Unfortunately, convention optical mouse devices do not adequately enable a user to operate the mouse without physically touching the device. This has the drawback, for example, that in an operating a room during a computer-aided surgical procedure, a surgeon's hands may become contaminated when he or she touches a mouse device. Before the surgeon can continue with the procedure, the surgeon's hands must be sterilized, which can unduly lengthen the surgical procedure. Similarly, in industrial situations, there are instances when an operator's hands could be crushed, or injured, because the location of a machine control requires the operator to expose himself or herself to risk of injury.

Therefore, it would be an advancement in the state of the art to provide an optical mouse that did not require physical contact by the operator.

It would also be an advancement in the state of the art to provide an optical mouse to improve detection of an operator's hand to increase the reliability of detection.

### SUMMARY

Thus, the present invention is directed to devices and methods of using an optical mouse that converts light energy to electrical signals, which are used to control an apparatus, as a function of the position of an object disposed in the light energy. One embodiment of the present invention is that the object (e.g. operator's hand) disposed in the light energy does not physically contact any other component. This enables an operator's hand from being contaminated by touching the outer casing, or body, or chassis of a mouse device. Thus, in a surgical room environment, a surgeon's hands will not become contaminated by touching a mouse device. Also, in industrial applications, a user can control an apparatus without exposing his or her hands to possible injury, since he or she does not have to physically touch the mouse device.

Accordingly, one embodiment of the present invention is directed to an apparatus for controlling a device based on a position of an object disposed in light energy, light energy may be for example: light rays; light irradiation; light waves; light photons, UV energy, IR energy and diffuse light. The position of the object does not have to physically touch the apparatus. This apparatus (hereinafter, “the apparatus”) includes a source of light energy and one or more sensor units. An object is disposed in the light energy. Light is reflected onto one more sensors as a function of a position of the object disposed in the light energy. Electrical signals are generated as a function of the light reflected on the portion of the one or more sensors. The electrical signals are used to control a second apparatus.

Another embodiment of the present invention is directed to the apparatus described above wherein the light energy has a wavelength exceeding the primary wavelength of light in the visible spectrum.

Yet another embodiment of the present invention is directed to the apparatus described above wherein the light energy has a wavelength shorter than the primary wavelength of visible light.

Yet another embodiment of the present invention is directed to the apparatus described above wherein the light energy has a wavelength in the visible spectrum.

Yet another embodiment of the present invention is directed to the apparatus described above and also includes focusing light energy reflected from the object disposed in the light energy.

Yet another embodiment of the present invention is directed to the apparatus described above and also includes sensing focused light energy reflected from an object disposed in the light energy.

Yet another embodiment of the present invention is directed to the apparatus described above wherein the object disposed in the light energy is a hand.

Yet another embodiment of the present invention is directed to the apparatus described above wherein the object disposed in the light energy is positioned independently of physical contact with any other object.

Yet another embodiment of the present invention is directed to the apparatus described above and also includes controlling a cursor.

Yet another embodiment of the present invention is directed to the apparatus described above and also includes controlling a motor.

Yet another embodiment of the present invention is directed to the apparatus described above and also includes controlling a processor.

Yet another embodiment of the present invention is directed to the apparatus described above and also includes a screen that reduces undesirable light reaching the light sensor.

Other embodiments of the present invention include the apparatus described above but implemented using a method or a computer program.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 shows a computer system including an optical mouse;

FIG. 2 illustrates one embodiment of the present invention;

FIG. 3 illustrates another embodiment of the present invention;

FIG. 4 shows an example of a system for controlling an apparatus according to the present invention; and

FIG. 5 illustrates an example of a method of using the optical mouse of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Generally, an optical mouse utilizes a light emitted from a light source. The light is reflected by an operating surface and the reflected light passes through a lens. This light is then input to an image sensor. The optical mouse measures a quantity of the light projected to the image sensor and stores a pattern made by comparing a difference between pixels of the image sensor. Then, a movement of the mouse is calculated by comparing a current pattern with a pattern made in a prior sample period. An integrated circuit includes an image sensor, having hundreds of pixels, for outputting signals accumulated for a given time as a pixel unit. An A/D converter receives the output of the image sensor and converts the output into a digital signal. An image data processor receives and calculates the output of the A/D converter and calculate a moving value V(X,Y) of the optical mouse.

The optical mouse samples a surface more than 1500 times per second. A light reflected by the surface in one sampling period is projected to the image sensor, and a current location of the optical mouse is calculated by using the projected value.

An embodiment of the present invention is a device and method for converting light energy to electrical signals as a function of the position of an object disposed in the light energy. A light source provides light energy. An object, such as an operator's hand, or other object, such as a scalpel, is disposed in the light at some distance from both the light source and a sensor unit. Light reflecting off the surface of the object disposed in the light is focused through a lens. The focused light illuminates the sensor. The light reflecting off the surface of the object and focused onto the sensor changes as a function of the position of the object in the light. The sensor converts light to electrical signals. As a result, the electrical signals are generated as a function of the position of the object disposed in the light energy.

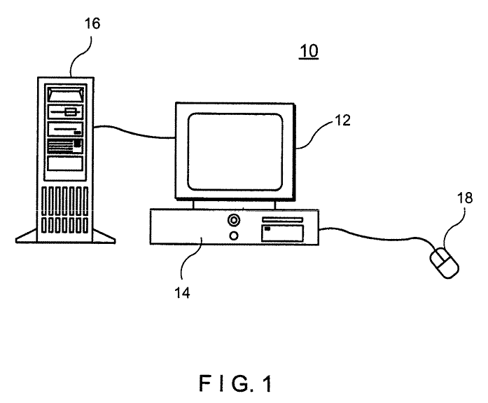

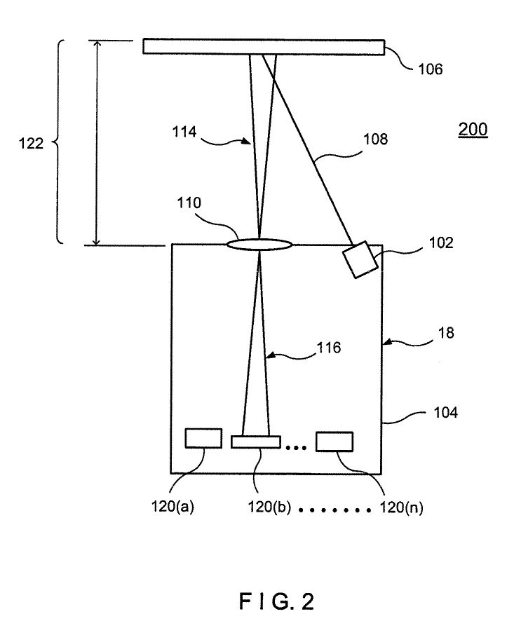

FIG. 1 shows a computer system 10 including an optical mouse. Computer system 10 includes processor 16, display device 12, a processor with keyboard 14 and mouse 18. Processor 16 is the part of a computer that interprets and executes instructions and has electronic storage for storing data and instructions. For example, the processor 16 may have a processing speed of 1.66 GHz, a 1 GB hard drive and SDRAM memory. Display device 12 may be, for example, a monitor, LCD display, plasma monitor, or other GUI (graphical user interface). The mouse 18 is an optical mouse that is couple to processor 16 via either a wired or wireless connection. The optical mouse 18 provides input signals that can be used for example to control a cursor on a display unit, or monitor 12. Optical mouse 18 is described in more detail in relation to FIG. 2.

FIG. 2 shows an illustrative example 200 of one embodiment of an optical mouse 18 of the present invention. The optical mouse 18 is adapted to generate electrical signals to control an apparatus as a function of the location of an object disposed in light energy. The apparatus may be a cursor on a computer screen, an operating table, industrial machine, or other apparatus that may be controlled with control signals. As shown in FIG. 2, the optical mouse 18 includes a source of light energy 102. The source of light energy 102 could be, for example, a bulb, an LED (light emitting diode), a laser diode, an infrared (IR) light source, an ultra-violet (UV) light source, high intensity laser, light rays, light irradiation, light waves, light photons, or could be diffuse light from any source including overhead lighting in a room or even sunlight coming from a window, or any combination of the above.

The source of light energy 102 creates light energy 108 to illuminate a surface of an object 106. The light energy 108 is typically rays of light that originates from source 102 and is directed at object 106.

The object 106 is disposed in the light energy 108 at a distance 122 from the light source 102. The object 106 is, for example, a hand, an instrument, such as a surgical scalpel or other opaque object that may be used to reflect light energy 108. Reflected light energy 114 is the result of light energy 108 being reflected from the surface of the object 106 and is focused through a lens 110, to form focused light 116. The lens 110 may be, for example, a converging lens, a Fresnel lens, polycarbonate lens, resin lens, concave or convex lens, or other suitable lens. The focused light 116 illuminates at least some portion of one or more sensors 120(a) . . . (n), where “n” is any suitable number.

The sensors 120(a) . . . (n) (generally referred to as sensor 120) are used to convert the focused light 116 into electrical signals. The sensor 120 may employ an array of microcrystals. Each microcrystal typically has a photo-detection unit and a light-focusing unit located between the photo-detection unit and the reflected light energy 114. These microcrystals may be used to detect reflected light 114 without the need for a separate light focusing mechanism or a light source capable of outputting concentrated light, such as a laser, diode, LED or other illumination source. A mirror or other means of reflecting light could also be used to intensify light energy 108 onto the object 106.

The sensor 120 may also be a photodetector that includes an array of pixels. The photodetector array will typically range in overall size from 1×1 mm to 7×7 mm, with each detector segment, or pixel, having dimensions in the range of 20×20 micrometers to 300×300 micrometers or more, where the exact dimensions are determined by the size of the overall array and the size of the individual detector. Each pixel typically includes a photodetector element and associated circuitry for conditioning the output of the photodetector element into a signal. Each pixel of the photodetector array may include a photosensitive area forming a photodiode (or alternatively, a phototransistor) and active circuitry including a preamplifier and a converter and comparator circuits for determining edge conditions between a pixel and at least one of its neighbors. Active circuitry may, for instance, include an integrating circuit for integrating and converting the photocurrent generated by the photosensitive region into an output signal usable for processing.

An integrating circuit consists of an integrating amplifier having a first input connected to the photosensitive element and another input connected to a reference potential (such as ground), as well as an integrating capacitor connected across the output and first input of the integrating amplifier. The current iₒᵤₜ generated by the photosensitive element is integrated over time on an integrating capacitor and provided as a voltage output signal Vₒᵤₜ on the integrating amplifier output. The integrating and reset phases of the integrating circuit are controlled by means of adequate control signals, in particular a RESET signal. Alternatively, the sensor 120 may transmit a light energy signal to another device, such as a processing device (shown as element 16 in FIG. 1) that converts the light energy signal to electrical signals.

A casing 104 assists the sensor 120 in detecting the focused light by preventing ambient light from inadvertently activating the sensor 120.

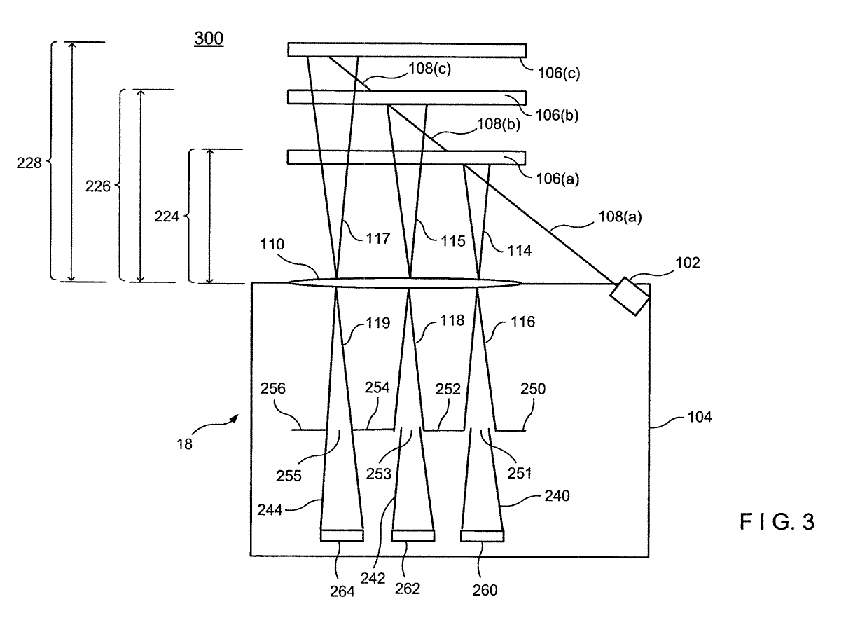

FIG. 3 shows another embodiment 300 of the present invention. A light source 102 generates light 108(a), which illuminates the surface of an object 106(a) disposed in the light 108(a) at a first distance, indicated as element 224.

Reflected light 114 is reflected from a surface of the object 106(a) and is focused by a lens 110. The focused light 116 passes through an opening, or aperture 251, between a first opaque, or solid, portion of a screen 250 and a second opaque or solid portion of a screen 252. The passed light, shown as element 240, illuminates at least a portion of a first sensor 260. The sensor 260 may convert the light to electrical signals or the sensor 260 may transmit a signal to another device that converts the light to electrical signals. The electrical signals can be used as control signals to control a cursor on a display device or control operation of a mechanical apparatus, such as an operating table, medical instrument table, or other medical or industrial machine.

The light source 102 may also illuminate the surface of an object 106(b) disposed at a second distance 226. This illuminating light is shown as light energy 108(b) and reflects off surface 106(b). Surface 106(b) may be another object or object 106 at a second position relative to the light source 102. For example, a user's hand may be located at distance 224 and form surface 106(a), when the user moves his or her hand, the hand may form surface 106(b) at distance 226.

Reflected light 115 is light 108(b) that has been reflected from surface 106(b), disposed at second distance 226. Reflected light 115 is focused by lens 10. The focused light 118 passes through an opening 253 between a second opaque or solid portion of a screen 252 and a third opaque or solid portion of a screen 254. The passed light 242 is the light energy that has passed through the opening 253 and illuminates at least a portion of a second sensor 262. The sensor 262 may convert the light to electrical signals or the sensor may transmit a signal to another device that converts the light to electrical signals. The electrical signals can be used as control signals to control a cursor on a display device or control operation of a mechanical apparatus such as an operating table, medical instrument table, or other medical or industrial machine.

The light source 102 may also illuminate and be reflected from the surface of an object 106(c) disposed at a third distance 228. This illuminating light is shown as light energy 108(c) and interfaces with surface 106(c). Surface 106(c) may be another object or object 106 at a third position relative to the light source 102. For example, a user's hand may be located at distance 224 and form surface 106(a), when the user moves his or her hand, the hand may be surface 106(c) at distance 228. Reflected light 117 is reflected from the surface of the object 106(c) disposed in the light 108(c) at a third distance 228 and is focused by a lens 110. The focused light 119 passes through an opening 255 between a third solid portion of a screen 254 and a fourth solid portion of a screen 256. The passed light 244 is the light energy that has passed through the opening 255 and illuminates at least a portion of a third sensor 264. The sensor 264 may convert the light to electrical signals or the sensor may transmit a signal to another device that converts the light to electrical signals.

The opaque or solid portions 250, 252, 254 and 256 reduce undesired focused light from reaching a sensor. For example, the aperture 251 channels focused light 116 to sensor 260 and reduces the chance that focused light 116 reaches sensor 262. Indeed, the second solid portion of a screen 252 helps prevent reflected light 114, as well as the focused light 116, from activating the second sensor 262. Similarly, the third opaque or solid portion of a screen 254 helps prevent focused light 118 from activating the third sensor 264. It is an alternate embodiment of the present invention that the opaque screen portions are not used and the sensors detect reflected light without apertures 251, 253, 255. It is also an embodiment of the present invention that the lens 110 is not used and the reflected light 114, 115 and 115 is not focused; but merely detected directly. Thus, while opaque screen portions 250, 252, 254, and 256 are shown, the optical mouse of the present invention could be implemented without the opaque screens and/or without the lens 110.

As shown by FIG. 3, the optical mouse as described herein improves identification of the distance of the surface of the object from the sensor. Identification of this distance enables the operator to provide an input by varying the distance from one or more sensors. The use of multiple sensors and apertures assists the collection of reflected light energy by increasing the surface area of the sensors.

While three sensors 260, 262 and 264 are shown in FIG. 3, alternate embodiments of the present invention may utilize a single sensor or a plurality of sensors. The number of sensors would be a function of the desired level of specificity, or granularity, of the detection. Also, while three distances 224, 226 and 228 are shown in FIG. 3, these are merely examples and virtually any number of distances may be utilized.

Furthermore, it is also an embodiment of the present invention that a single sensor unit, which is sensitive to the intensity of light, could be used to detect the distance of the object from the sensor since the intensity of the light reflected from the object varies inversely with the distance of the object from the sensor.

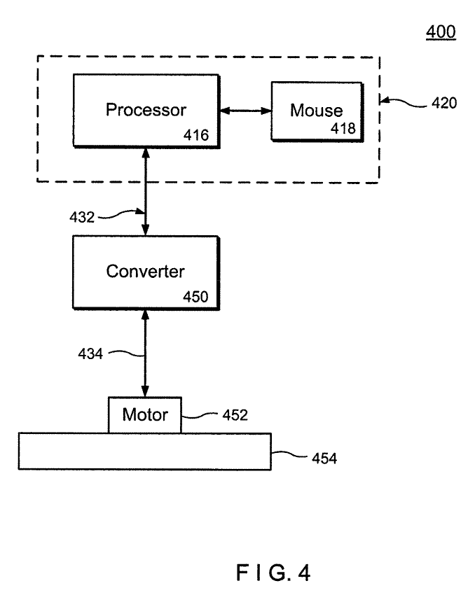

FIG. 4 shows a system 400 that includes an optical mouse 418 according to the present invention used to control an apparatus 454, which may be, for example, a medical instrument table, an operating table, a patient lifting apparatus, a processor, an industrial lift or other apparatus that may be controlled by electrical signals. As shown in FIG. 4, element 420 shows that the processor 416 and the optical mouse 418 may be a single unit 420. This embodiment may be used when the optical mouse 418 is used to control an apparatus that may not be on a computer display device. For example, optical mouse 418 with processor unit 416 (element 420) may be electronically couple to a converter unit 450. By providing the mouse 416 with storage and processing functionality, the mouse unit 420 may be used with any compatible apparatus that can be controlled with electrical signals. For example, the mouse unit 420 and converter unit 450 may have a port (not shown), such as a USB port, to connect to a port of motor 452 and/or the apparatus 454.

System 400 includes processor and storage unit 416, mouse 418, converter unit 450, actuator, or motor 452, and an apparatus 454. Processor and storage unit 416 is adapted to store and process signals generated by optical mouse device 418. The optical mouse 418 is used to generate control signals based on detection of an object, such as a user's hand, medical instrument, or other article, used to generate control signals. The optical mouse can generate signals based on a position of an object and does not require physical contact with the body of the mouse 418.

The converter unit 450 may be coupled to the optical mouse with processing capabilities 420 either via a wired connection (e.g., a USB bus, IEEE bus, DSL line, or other suitable transmission cable) or wireless connection (e.g., IR, wireless modem, or other suitable wireless transmission medium) (connection shown generally as element 432). Alternatively, the converter unit 450 may be integral to the mouse unit 420, or coupled to the processing unit 416. Regardless of whether the converter unit 450 is coupled to the processor 416 or an optical mouse with processing capabilities 420, or integral to the mouse unit 420, the converter unit 450 receives signals generated by the optical mouse 418 and converts the electrical signals to control signals. These control signals are transmitted to actuator unit, or motor unit, 452, via either a wired or wireless connection (connection shown generally as element 434). The actuator unit, or motor, 452 moves, or adjusts, a position of apparatus 454 based on the signals generated by optical mouse 418. An operator could use the optical mouse unit 418, 420 to move a table or a tray 454 without physically contacting any object. Thus a mouse unit 420 with storage and processing capabilities and converter unit may be a portable device that can be coupled to any electronic device and used to control the electronic device without the user physically touching a body of the mouse device while controlling the electronic device.

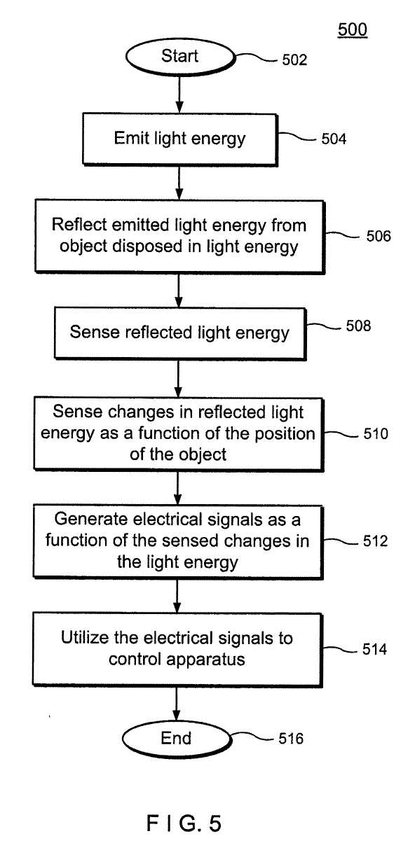

FIG. 5 shows a method 500 of using of the optical mouse of the present invention. This method 500 is typically a series of steps, or an algorithm, that may be stored on a computer-readable medium and executed by a processor. The method 500 may be stored in an electronic memory medium, such as found in processor 16, shown in FIG. 1. The method begins with step 502. Light energy is emitted, as shown in step 504. The emitted light may be generated by a light source or may be diffuse, ambient light energy. Emitted light is reflected from a surface of an object, as shown in step 506. The reflected light is sensed, as shown in step 508. Changes in the reflected light energy are sensed. The sensing is performed as a function of the position of the object disposed in the light energy, shown in step 510. Step 512 shows that electrical signals are generated as a function of the sensed reflected light energy. The electrical signals are used to control an apparatus, as shown in step 514. End step 516 shows that the algorithm ends.

As discussed herein, one embodiment of the present invention is directed to an optical mouse apparatus for a computer system. This mouse apparatus may include, inter alia, means for emitting light energy, such as a laser, diode, series of LEDS (light emitting diodes), IR source, UV source, diffuse ambient light or other illumination source that can provide light energy. The light energy could be in the form of photons, rays, waves, or other illumination transmission. The mouse apparatus may also include an object that reflects at least a portion of the light energy. This object may be an operator's hand, an instrument, or other article that adequately reflects the light from the light source. The computer mouse apparatus may also include means for sensing the reflected light. This may include a sensor, a series of photoelectric detectors. Furthermore, the computer mouse may include means for generating electrical signals as a function of the sensed light. This may include a converter module such as photovoltaic devices, a photo sensor or CCD chip or photo multiplier. The sensing of light and converting the sensed light into an electrical signal may be performed by separate sensing and converting devices or by a combined photovoltaic device or devices. The mouse may also include means for utilizing the electrical signals to control a second apparatus. This may be, for example, an actuator, a processor or a motor or part of a feedback loop such that as an operator moves their hand or instrument the device being controlled moves as a function of the operator's movement. Thus when an operator moves their hand up, the device (operating table, instrument tray etc. also moves upwardly. As an operator moves their hand down, the device (operating table, instrument tray etc. also moves downward. Thus, while the operator could control a cursor in a computer-aided diagnosis procedure, an operator could also control an operating table, instrument tray, an industrial pallet or other object controlled by electrical signals. It is also an embodiment of the present invention that the object disposed in the light energy does not physically contact any other component. This enables an operator's hand from being contaminated by touching the outer casing, or body, or chassis of a mouse device. Thus, in a surgical room environment, a surgeon's hands will not become contaminated by touching a mouse device during a computer-aided surgical procedure. Also, in industrial applications, a user can control an apparatus without exposing their hands to possible injury, since he or she does not have to physically touch the mouse device.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method, comprising:
providing light energy;
reflecting at least a portion of the light energy as a function of a position of an object disposed in the light energy;
sensing the reflected light energy;
generating electrical signals as a function of the sensed light energy; and
utilizing the electrical signals to control an apparatus,
wherein the object is positioned independent of physical contact with any component.

2. The method according to claim 1, wherein the light energy primarily has a wavelength exceeding the wavelength of visible light.

3. The method according to claim 1, wherein the light energy primarily has a wavelength less than a wavelength of visible light.

4. The method according to claim 1, wherein the light energy primarily has a wavelength in the visible spectrum.

5. The method according to claim 1, further comprising:
focusing the light energy reflected from the object.

6. The method according to claim 5, further comprising:
sensing the focused light energy.

7. The method according to claim 1, wherein the object is a hand.

8. The method according to claim 1, wherein the object is positioned independently of physical contact with any other object.

9. The method according to claim 1, wherein the apparatus is a cursor.

10. The method according to claim 1, wherein the apparatus is a motor.

11. The method according to claim 1, wherein the apparatus is a processing device.

12. The method according to claim 1, further comprising:
reducing ambient light energy sensed.

13. An apparatus, comprising:
a light source adapted to emit light energy;
an object, disposed in a path of the light energy, that reflects light energy emitted from the light source; and
one or more sensor units adapted to receive the reflected light energy and generate electrical signals as a function of the received reflected light energy,
wherein the electrical signals are used to control a second apparatus, and
wherein the object is positioned independent of physical contact with any component.

14. The apparatus according to claim 13, wherein the light energy primarily has a wavelength exceeding the wavelength of visible light.

15. The apparatus according to claim 13, wherein the light energy primarily has a wavelength less than the wavelength of visible light.

16. The apparatus according to claim 13, wherein the light energy primarily has a wavelength in the visible spectrum.

17. The apparatus according to claim 13, further comprising:
means for focusing the reflected light energy.

18. The apparatus according to claim 17, wherein the means for focusing the reflected light energy is a lens.

19. The apparatus according to claim 13, wherein the object is a hand.

20. The apparatus according to claim 13, wherein the object is positioned independently of physical contact with the second apparatus.

21. The apparatus according to claim 13, wherein the second apparatus is a cursor.

22. The apparatus according to claim 13, wherein the second apparatus is a motor.

23. The apparatus according to claim 13, wherein the second apparatus is a processor.

24. The apparatus according to claim 13, further comprising means for reducing undesirable light reaching the one or more sensor units.

25. A mouse apparatus, comprising:
means for emitting light energy;
an object that reflects at least a portion of the light energy;
means for sensing the reflected light;
means for generating electrical signals as a function of the sensed light; and
means for utilizing the electrical signals to control a second apparatus,
wherein the object disposed in the light energy does not physically contact another component.

26. The mouse apparatus according to claim 25, further comprising means for focusing the reflected light.
